(19) United States
(12) Patent Application Publication
(10) Pub. No.: US 2026/0329463 A1
(43) Pub. Date: Oct. 22, 2026

(54) MEMORY DEVICE AND OPERATING METHOD THEREOF

(71) Applicant: SK hynix Inc., Icheon-si (KR)

(72) Inventor: Byung Goo CHO, Icheon-si (KR)

(21) Appl. No.: 19/466,858

(22) Filed: Feb. 2, 2026

(30) Foreign Application Priority Data
Apr. 22, 2025 (KR) 10-2025-0052311

(51) Int. Cl. G06F 3/06

(52) U.S. Cl. CPC G06F 3/064; G06F 3/0604; G06F 3/0679

(57) ABSTRACT

The present disclosure relates to a memory device may include a memory cell array including first-type memory blocks, to which main memory block addresses are allocated and in which user data is stored, and second-type memory blocks in which no user data is stored, an address management circuit configured to request a read operation for the second-type memory blocks and to set flag information indicating a usage status of each of the second-type memory blocks based on data read from each of the second-type memory blocks, and an address adjustment circuit configured to selectively allocate, based on the flag information for each of the second-type memory blocks, a main memory block address to the second-type memory blocks.

### CROSS-REFERENCE TO RELATED APPLICATION

The present application claims priority under 35 U.S.C. § 119(a) to Korean patent application number 10-2025-0052311, filed on Apr. 22, 2025, which is incorporated herein by reference in its entirety.

### BACKGROUND

### Field of Invention

The present disclosure relates to an electronic device, and more particularly, to a memory device and an operating method thereof.

### Description of Related Art

Non-volatile memory devices have a characteristic that data programming and erasing are performed electrically.

A memory device includes a plurality of memory blocks, which include main memory blocks capable of storing user data and special-purpose memory blocks to which user access is restricted. For example, extended blocks, extra blocks, and spare blocks are the special-purpose memory blocks. The special-purpose memory blocks are set as spaces for storing data other than the user data. Users cannot access the special-purpose memory blocks except in special circumstances.

Meanwhile, some special-purpose memory blocks may remain in an erased state. These special-purpose memory blocks may stay unused in that state until the memory device is discarded. In other words, when there are many unused special-purpose memory blocks within the memory device, this may reduce the user data storage capacity and degrade the performance of the memory device.

### SUMMARY

Various embodiments are directed to a memory device that can increase the storage capacity for user data.

According to an embodiment, a memory device may include first-type memory cell array including memory blocks, to which main memory block addresses are allocated and in which user data is stored, and second-type memory blocks in which no user data is stored, an address management circuit configured to request a read operation for the second-type memory blocks and to set flag information indicating a usage status of each of the second-type memory blocks based on data read from each of the second-type memory blocks, and an address adjustment circuit configured to selectively allocate, based on the flag information for each of the second-type memory blocks, a main memory block address to the second-type memory blocks.

According to an embodiment, a memory device may include a memory cell array including first-type memory blocks, to which main memory block addresses are allocated and in which user data is stored, and second-type memory blocks in which no user data is stored, an address management circuit configured to store preset flag information indicating a usage status of each of the second-type memory blocks, and an address adjustment circuit configured to allocate a main memory block address of to the second-type memory blocks based on the preset flag information.

### BRIEF DESCRIPTION OF THE DRAWINGS

FIG. 1 illustrates a memory device according to an embodiment of the present disclosure;

FIG. 2 illustrates a memory block included in a memory cell array shown in FIG. 1;

FIG. 3 illustrates a method of operating an address management circuit, a data verification circuit, an address decoder, and an address adjustment circuit shown in FIG. 1;

FIG. 4 illustrates a verification circuit shown in FIG. 3;

FIG. 5 illustrates a main memory block address allocation method of the address adjustment circuit shown in FIG. 3;

FIG. 6 illustrates an address allocation method for a second-type memory block according to an embodiment of the present disclosure;

FIG. 7 illustrates a memory device according to another embodiment of the present disclosure;

FIG. 8 illustrates a memory card system according to an embodiment of the present disclosure; and

FIG. 9 illustrates a Solid State Drive (SSD) system according to an embodiment of the present disclosure.

### DETAILED DESCRIPTION

Specific structural or functional descriptions of examples of embodiments in accordance with concepts which are disclosed in this specification are illustrated only to describe the examples of embodiments in accordance with the concepts and the examples of embodiments in accordance with the concepts may be carried out by various forms but the descriptions are not limited to the examples of embodiments described in this specification.

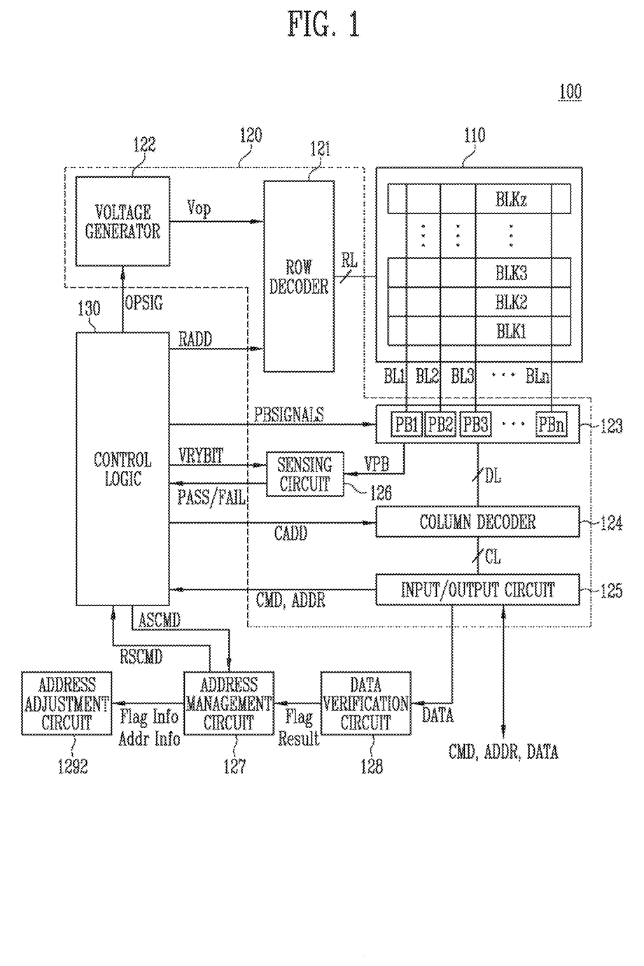

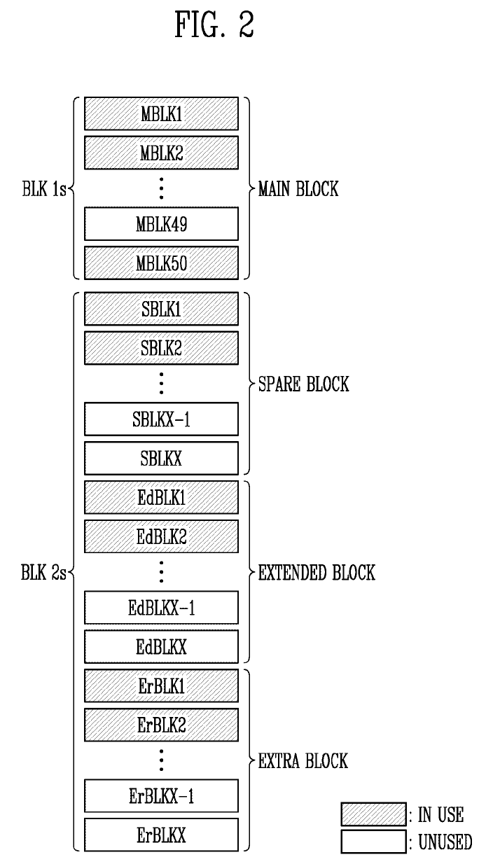

FIG. 1 illustrates a memory device 100 according to an embodiment of the present disclosure, and FIG. 2 illustrates a memory block included in a memory cell array 110 shown in FIG. 1.

Referring to FIG. 1, the memory device 100 may include the memory cell array 110, a peripheral circuit 120, and control logic 130.

The memory cell array 110 includes a plurality of memory blocks BLK1 to BLKz, z being a positive integer greater than 1. The plurality of memory blocks BLK1 to BLKz are coupled to a row decoder 121 via row lines RL. The plurality of memory blocks BLK1 to BLKz may be coupled to a page buffer group 123 via bit lines BL1 to BLn, n being a positive integer greater than 1. Each of the plurality of memory blocks BLK1 to BLKz includes a plurality of memory cells. In an embodiment, the plurality of memory cells are non-volatile memory cells. Memory cells coupled to the same word line may be defined as a page. Therefore, a memory block may include a plurality of pages.

The memory cells included in the memory cell array 110 may include a single-level cell (SLC) which stores one data bit, a multi-level cell (MLC) which stores two data bits, a triple-level cell (TLC) which stores three data bits, or a quadruple-level cell (QLC) which stores four data bits.

Referring to FIG. 2, the memory cell array 110 includes memory blocks BLK 1s of a first type (hereinafter, also referred to as ‘first-type memory blocks BLK 1s’) and memory blocks BLK 2s of a second type (hereinafter, also referred to as ‘second-type memory blocks BLK 2s’).

The first-type memory blocks BLK 1s are main memory blocks where user data is stored. In response to user commands, the peripheral circuit 120 may perform a program operation, a read operation, and an erase operation on the first-type memory blocks BLK 1s.

The second-type memory blocks BLK 2s are memory blocks which cannot store user data. Regardless of user commands, the peripheral circuit 120 cannot perform a program operation, a read operation, or an erase operation on the second-type memory blocks BLK 2s.

The second-type memory blocks BLK 2s include spare blocks, extended blocks, and extra blocks. A spare block is used to replace a bad block. An extra block may serve as a Content Addressable Memory (CAM) block or a One Time Programmable (OTP) memory block. An extended block may be designated to extend the capacity of a main memory block.

Each of the first-type memory blocks BLK 1s is a memory block where user data is stored and user access is permitted, and each of the second-type memory blocks BLK 2s is a memory block where the user data is not stored. Each of the first-type memory blocks BLK 1s and the second-type memory blocks BLK 2s may be in a used state with stored data or in an unused state with no data.

Referring to FIG. 1, the peripheral circuit 120 may be configured to perform a program operation, a read operation, or an erase operation on a selected area of the memory cell array 110 under the control of the control logic 130. The peripheral circuit 120 may drive the memory cell array 110. For example, the peripheral circuit 120 may apply various operation voltages to the row lines RL and the bit lines BL1 to BLn or may discharge the applied voltages under the control of the control logic 130.

The peripheral circuit 120 may include the row decoder 121, a voltage generator 122, the page buffer group 123, a column decoder 124, an input/output circuit 125, a sensing circuit 126.

The row decoder 121 is coupled to the memory cell array 110 via the row lines RL. The row lines RL may include at least one source select line, a plurality of word lines, and at least one drain select line. In an embodiment, the word lines may include normal word lines and dummy word lines. In an embodiment, the row lines RL may further include a pipe select line.

The row decoder 121 is configured to decode a row address RADD received from the control logic 130. The row decoder 121 selects at least one memory block from the memory blocks BLK1 to BLKz based on the row address RADD. In addition, the row decoder 121 may select at least one word line of the selected memory block to apply voltages generated by the voltage generator 122 to at least one word line WL based on the row address RADD.

For example, during a program operation, the row decoder 121 applies a program voltage to the selected word line and applies a program pass voltage lower than the program voltage to unselected word lines. During a program verify operation, the row decoder 121 applies a verify voltage to the selected word line and a verify pass voltage higher than the verify voltage to the unselected word lines. During a read operation, the row decoder 121 applies a read voltage to the selected word line and applies a read pass voltage higher than the read voltage to the unselected word lines.

In an embodiment, an erase operation of the memory device 100 is performed in memory block units. During the erase operation, the row decoder 121 may select one memory block based on the row address RADD. During the erase operation, the row decoder 121 may apply a ground voltage to the word lines coupled to the selected memory block.

The voltage generator 122 operates under the control of the control logic 130. The voltage generator 122 is configured to generate a plurality of voltages using an external power supply voltage supplied to the memory device 100. More specifically, the voltage generator 122 may generate various operation voltages Vop used for a program operation, a read operation, and an erase operation in response to an operation signal OPSIG. For example, the voltage generator 122 may generate a program voltage, a verify voltage, a pass voltage, a read voltage, and an erase voltage under the control of the control logic 130.

In an embodiment, the voltage generator 122 may regulate the external power supply voltage to generate an internal power supply voltage. The internal power supply voltage generated by the voltage generator 122 is used as the operation voltage for the memory device 100.

In an example, the voltage generator 122 may generate a plurality of voltages using the external power supply voltage or the internal power supply voltage.

For example, the voltage generator 122 includes a plurality of pumping capacitors which receive the internal power supply voltage, and selectively activates the plurality of pumping capacitors under the control of the control logic 130 to generate the plurality of voltages. The plurality of voltages may be supplied to the memory cell array 110 by the row decoder 121.

The page buffer group 123 includes page buffers PB1 to PBn. The buffers PB1 to PBn are coupled to the memory cell array 110 through the bit lines BL1 to BLn. The page buffers PB1 to PBn operate under the control of the control logic 130. More specifically, the page buffers PB1 to PBn may operate in response to page buffer control signals PBSIGNALS from the control logic 130. For example, the page buffers PB1 to PBn may temporarily store data received through the bit lines BL1 to BLn, or may sense voltages or currents of the bit lines BL1 to BLn during a read or verify operation.

More specifically, during a program operation, when a program voltage is applied to the selected word line, the page buffers PB1 to PBn may transfer data DATA received through the input/output circuit 125 to selected memory cells via the bit lines BL1 to BLn. Memory cells of a selected page are programmed based on the transferred data DATA. During a program verify operation, the page buffers PB1 to PBn sense the voltage or current received from the selected memory cells through the bit lines BL1 to BLn to verify data stored in the selected page.

During a read operation, the page buffers PB1 to PBn may read the data DATA from the memory cells of the selected page through the bit lines BL1 to BLn and may output the read data DATA to the input/output circuit 125 under the control of the column decoder 124.

During an erase operation, the page buffers PB1 to PBn may float the bit lines BL1 to BLn or apply an erase voltage to the bit lines BL1 to BLn.

The column decoder 124 may transfer data between the input/output circuit 125 and the page buffer group 123 based on a column address CADD. For example, the column decoder 124 may exchange data with the page buffers PB1 to PBn through data lines DL or exchange data with the input/output circuit 125 through column lines CL.

The input/output circuit 125 may transfer a command CMD and an address ADDR received from a memory controller (not shown) to the control logic 130, or may exchange data DATA with the column decoder 124.

The sensing circuit 126 generates a reference current in response to an allowable bit signal VRYBIT, compares a reference voltage generated by the reference current with a sensing voltage VPB received from the page buffer group 123, and outputs a pass signal PASS or a fail signal FAIL during a read operation or a verify operation.

The address management circuit 127 may request the control logic 130 to perform a read operation on the second-type memory blocks BLK 2s and may store flag information Flag Info for each of the second-type memory blocks BLK 2s based on whether read data is present in the corresponding second-type memory block.

The flag information Flag Info indicates whether data is stored in each of the second-type memory blocks BLK 2s. In other words, the flag information Flag Info may indicate whether the corresponding second-type memory block is in an erased state or not. In other words, the flag information Flag Info may indicate whether the corresponding second-type memory block is in a used state or an unused state.

The data verification circuit 128 may fetch data from each of the second-type memory blocks BLK 2s through the input/output circuit 125 after a read operation is performed on the second-type memory blocks BLK 2s. The data verification circuit 128 outputs a flag value Flag Result based on the data of each of the second-type memory blocks BLK 2s. The flag value Flag Result may be output as a plurality of values. Among the plurality of values, the final flag value Flag Result is set and stored as the flag information Flag Info of the corresponding second-type memory block in the address management circuit 127. The address management circuit 127 provides the flag information Flag Info and address information Addr Info of the corresponding second-type memory block to the address adjustment circuit 1292.

The address adjustment circuit 1292 receives the flag information Flag Info and the address information Addr Info from the address management circuit 127. The address adjustment circuit 1292 allocates a first-type memory block address to a second-type memory block which remains unused based on the flag information Flag Info, the address information Addr Info, and last main memory block address information LMB Address Info stored therein. The last main memory block address information LMB Address Info may include information on a main memory block address most recently allocated to a memory block for storing user data, i.e., the last main memory block address.

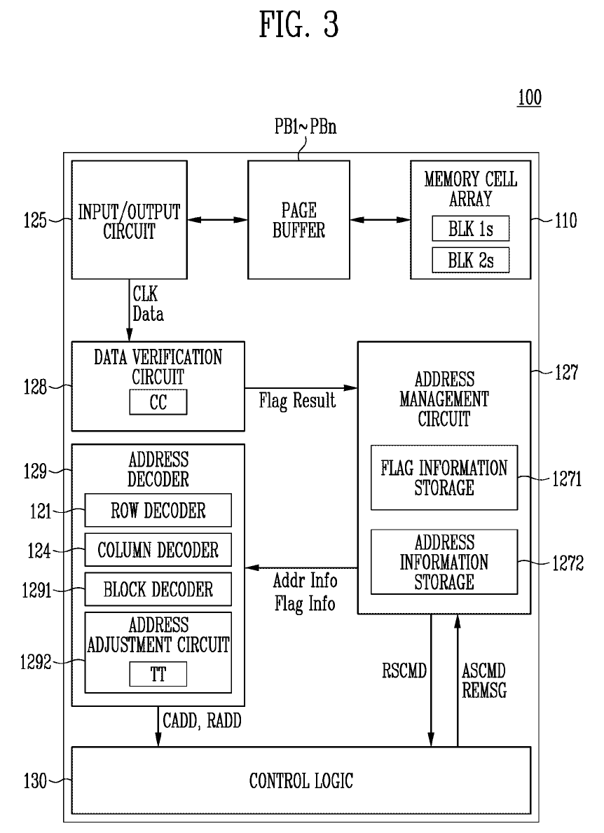

FIG. 3 illustrates operations of the address management circuit 127, the data verification circuit 128, an address decoder 129, and the address adjustment circuit 1292 shown in FIG. 1.

Referring to FIG. 3, when a condition for increasing storage capacity is satisfied or when the use of the configuration block is completed prior to device mounting, the control logic 130 removes access restrictions from the second-type memory blocks BLK 2s and then transfers an address allocation command ASCMD to the address management circuit 127. Once the access restrictions on the second-type memory blocks BLK 2s are lifted, the peripheral circuit 120 in FIG. 1 may perform a read operation on the second-type memory blocks BLK 2s within the memory cell array 110. The access restrictions may be lifted with priority for all or at least one of the spare blocks, the extended blocks, or the extra blocks among the second-type memory blocks BLK 2s.

The address management circuit 127 receives the address allocation command ASCMD from the control logic 130 and transfers a read start command RSCMD to the control logic 130 in response to the address allocation command ASCMD. The address management circuit 127 stores the address information Addr Info for all second-type memory blocks BLK 2s. Based on the address information Addr Info for the second-type memory blocks BLK 2s, the spare blocks, the extended blocks, and the extra blocks may be identified. When the access restrictions are lifted for at least one of the spare blocks, the extended blocks, or the extra blocks, the address management circuit 127 may transfer the read start command RSCMD for at least one second-type memory block whose restrictions have been lifted.

The address management circuit 127 transfers the read start command RSCMD to the control logic 130 for all target memory blocks based on the address information Addr Info for the second-type memory blocks BLK 2s. A request for the read start command RSCMD from the address management circuit 127 may include transferring a read command for all second-type memory blocks BLK 2s corresponding to addresses ranging from the first address to the last address of the second-type memory blocks BLK 2s to the control logic 130. Alternatively, the address management circuit 127 may transfer the read start command RSCMD for at least one of the spare block, the extended block, or the extra block, or may transfer the read start command RSCMD to the control logic 130 in a specified order among the spare block, the extended block, and the extra block.

The control logic 130 may control the peripheral circuit 120 to perform a read operation on the second-type memory blocks BLK 2s in response to the read start command RSCMD. The peripheral circuit 120 performs the read operation based on addresses of the second-type memory blocks BLK 2s included in the read start command RSCMD. Read data DATA from the second-type memory blocks BLK 2s in the memory cell array 110 is stored in the page buffer PB and provided to the data verification circuit 128 through the input/output circuit 125.

The address management circuit 127 includes a flag information storage 1271 for storing the flag information Flag Info and an address information storage 1272 for storing the address information Addr Info.

The address management circuit 127 stores the final flag value Flag Result, which is the final calculation value for the second-type memory block received from the data verification circuit 128, as the flag information Flag Info in the flag information storage 1271. The flag value Flag Result is a value calculated and output by the data verification circuit 128 for each of the second-type memory blocks BLK 2s. The flag information Flag Info refers to information regarding whether data is stored in each of the second-type memory blocks BLK 2s or whether each of the second-type memory blocks BLK 2s is used or unused. In other words, the data verification circuit 128 sequentially receives the read data DATA for each of the second-type memory blocks BLK 2s and outputs a plurality of flag values Flag Result using an operation circuit. The final flag value Flag Result output for each of the second-type memory blocks BLK 2s may be stored in the address management circuit 127 as the flag information Flag Info.

In addition, the address management circuit 127 may store the address information Addr Info in the address information storage 1272. The address information Addr Info refers to an address of a second-type memory block corresponding to the flag information Flag Info. The address information Addr Info may be used to identify the second-type memory block having the flag information Flag Info, or may be used when a main memory block address has not been allocated to the second-type memory block.

When the read operation for the second-type memory blocks BLK 2s is completed, the address management circuit 127 may receive a read completion message REMSG from the control logic 130 indicating that the read operation for the second-type memory blocks BLK 2s is complete.

When the address management circuit 127 receives the read completion message REMSG, the address management circuit 127 provides the stored flag information Flag Info and the corresponding address information Addr Info to the address adjustment circuit 1292.

The data verification circuit 128 receives the read data DATA from the second-type memory blocks BLK 2s provided through the input/output circuit 125 from the page buffers PB1 to PBn of the page buffer group 123. The data verification circuit 128 inputs the read data DATA into a verification circuit CC to check whether data exists within each of the second-type memory blocks BLK 2s, and outputs the flag value Flag Result as a result value.

The data verification circuit 128 includes the verification circuit CC for checking whether data is stored in each of the second-type memory blocks BLK 2s. The verification circuit CC receives the read data DATA from each of the second-type memory blocks BLK 2s and outputs the flag value Flag Result. Data DATA in a single memory block may correspond to DQ[n-1:0], which includes n bits of input data. A flag value Flag Result may be output for each clock (CLK) cycle. Among the flag values Flag Result related to the respective second-type memory block BLK 2s, the final flag value Flag Result is used as the flag information Flag Info.

The data verification circuit 128 may output different flag values Flag Result depending on whether data is stored in the corresponding memory block BLK 2s. The flag value Flag Result serves as information for distinguishing whether the second-type memory block BLK 2s is in an erased state or a non-erased state, and also for determining whether the second-type memory block BLK 2s is in use or unused. When a flag value Flag Result for an unused second-type memory block is ‘1,’ a flag value Flag Result for a used second-type memory block may be set to ‘0.’

For example, when read data from a predetermined second-type memory block is in the erased state, i.e., ALL FFH (0xFFFFFFFF), the verification circuit CC may output the flag value Flag Result as ‘1.’ When data exists in at least one memory cell within the predetermined second-type memory block, the verification circuit CC may output the flag value Flag Result as ‘0,’ and the flag information Flag Info may also be ‘0.’ Alternatively, the output flag values may be opposite to those described above.

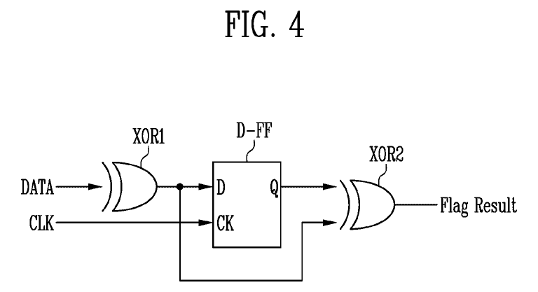

FIG. 4 illustrates the verification circuit CC shown in FIG. 3.

Referring to FIG. 4, the verification circuit CC may include a first exclusive OR gate XOR1, a D flip-flop D-FF, and a second exclusive OR gate XOR2.

The first exclusive OR gate XOR1 performs an exclusive OR operation on read data DATA from a second-type memory block at an input terminal thereof and provides an output to a D input terminal of the D flip-flop D-FF. The read data DATA input to the input terminal of the first exclusive OR gate XOR1 may be DQ[7:0].

The D flip-flop D-FF includes the D input terminal which receives the output of the first exclusive OR gate XOR1, a clock input terminal receiving a clock signal CLK, and an output terminal. The D flip-flop performs a D flip-flop operation and outputs a result through the output terminal. The second exclusive OR gate XOR2 may include a first input terminal which receives an output of the D flip-flop D-FF and a second input terminal which receives the output of the first exclusive OR gate XOR1, and an output terminal which outputs a result of performing an exclusive OR operation on the output of the D flip-flop D-FF and the output of the first exclusive OR gate XOR1.

Since the first and second input terminals of the second logic gate XOR2 receive both the output of the D flip-flop D-FF and the input of the D flip-flop D-FF simultaneously, the final flag value Flag Result output from the second logic gate XOR2 may indicate whether data is stored in the second-type memory block. That is, when the final flag value Flag Result is ‘1,’ the second-type memory block is determined to be in an erased state and unused. When the final flag value Flag Result is ‘0,’ the second-type memory block is determined to be in a state where data is stored and in use.

The final flag value Flag Result output from the second logical OR gate XOR2 is provided to the address management circuit 127, and the final flag value Flag Result may be set as the flag information Flag Info and may be stored in the flag information storage 1271 in FIG. 3. The address management circuit 127 provides the stored flag information Flag Info and the corresponding stored address information Addr Info to the address decoder 129.

Referring back to FIG. 3, the address decoder 129 includes the row decoder 121, the column decoder 124, a block decoder 1291, and the address adjustment circuit 1292.

The row decoder 121 receives the row address RADD from among addresses. The row decoder 121 decodes the row address RADD to generate a row select signal for selecting one of the word lines WL.

The column decoder 124 receives the column address CADD from among the addresses. The column decoder 124 decodes the column address CADD to generate a column select signal for selecting one of the bit lines BL.

The address adjustment circuit 1292 allocates, to each unused second-type memory block BLK 2s, a main memory block address (or first-type memory block address) that is allocated to a memory block to store user data, and stores and manages the allocated main memory block address in an adjustment table TT. The allocation of the main memory block address to each unused second-type memory block BLK 2s may be performed based on the flag information Flag Info, the address information Addr Info, and the last main memory block address information LMB Addr Info.

The main memory block address allocated to the unused second-type memory block BLK 2s is the next main memory block address following the last main memory block address in the last main memory block address information LMB Addr Info.

The adjustment table TT stores, as a first mapping memory block address, a second-type memory block address of the unused second-type memory block, and stores, as a second mapping memory block address corresponding to the first mapping memory block address, the main memory block address mapped to the first mapping memory block address.

After that, when the address adjustment circuit 1292 receives a block address for accessing a memory block, the address adjustment circuit 1292 determines whether the received block address corresponds to the first mapping memory block address recorded in the adjustment table TT. When the received block address corresponds to the first mapping memory block address, the address adjustment circuit 1292 converts the first mapping memory block address into the second mapping memory block address and provides the converted second mapping memory block address to the block decoder 1291 as a memory block address for memory block selection. When the received block address does not correspond to the first mapping memory block address, the address adjustment circuit 1292 provides the received block address to the block decoder 1291 as the memory block address.

The block decoder 1291 may receive the memory block address from the address adjustment circuit 1292, decode the received memory block address, and selectively generate a signal for the memory block selection based on the decoded memory block address.

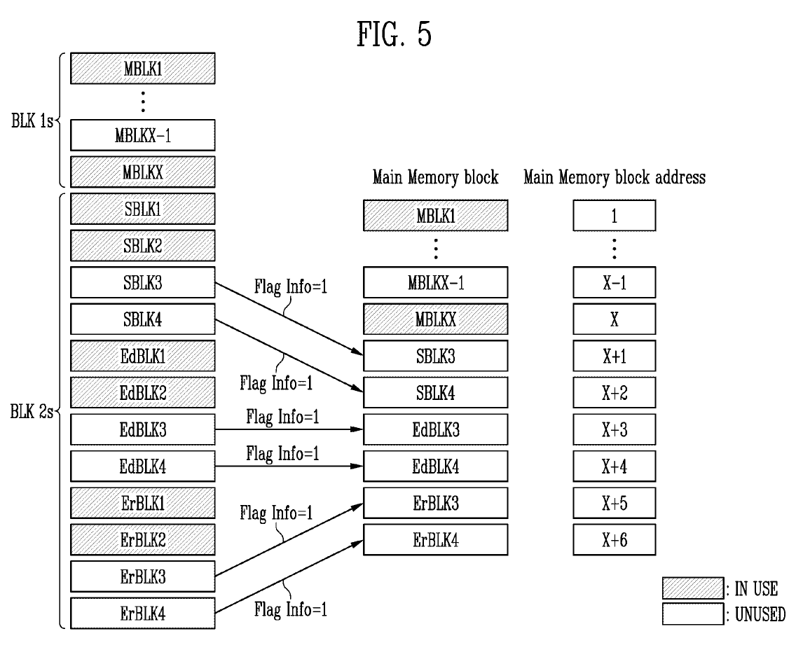

FIG. 5 illustrates a main memory block address allocation method of the address adjustment circuit 1292 shown in FIG. 3.

Referring to FIG. 5, a first-type memory block BLK 1s refers to a main memory block where user data is stored. Since each first-type memory block BLK 1s serves as a storage region for user data, whether each first-type memory block is used or unused is irrelevant. The last main memory block address information LMB Addr Info is represented as ‘X.’

For simplicity, it is assumed that the second-type memory blocks BLK 2s include first to fourth spare blocks SBLK1 to SBLK4, first to fourth extended blocks EdBLK1 to EdBLK4, and first to fourth extra blocks ErBLK1 to ErBLK4.

The first and second spare blocks SBLK1 and SBLK2 are in use, and corresponding flag information Flag Info is ‘0.’ The third and fourth spare blocks SBLK3 and SBLK4 are unused, and corresponding flag information Flag Info is ‘1.’

The address adjustment circuit 1292 allocates main memory block addresses to the third and fourth spare blocks SBLK3 and SBLK4 whose flag information Flag Info is ‘1.’ More specifically, since the last main memory block address information LMB Addr Info is ‘X,’ a main memory block address ‘X+1’ is allocated to the third spare block SBLK3, a main memory block address ‘X+2’ is allocated to the fourth spare block SBLK4, and these addresses are stored in the adjustment table TT. In this case, the last main memory block address information LMB Addr Info is updated to ‘X+2.’

The first and second extended blocks EdBLK1 to ErBLK2 are in use, and corresponding flag information Flag Info is ‘0.’ The third and fourth extended blocks EdBLK3 and EdBLK4 are unused, and corresponding flag information Flag Info is ‘1.’

The address adjustment circuit 1292 allocates main memory block addresses to the third and fourth extended blocks EdBLK3 and EdBLK4 whose flag information Flag Info is ‘1.’ More specifically, since the last main memory block address information LMB Addr Info is ‘X+2,’ a main memory block address ‘X+3’ is allocated to the third extended block EdBLK3, a main memory block address ‘X+4’ is allocated to the fourth extended block EdBLK4, and these main block memory addresses are stored in the adjustment table TT. In this case, the last main memory block address information LMB Addr Info is updated to ‘X+4.’

The first and second extra blocks ErBLK1 and ErBLK2 are in use, and corresponding flag information Flag Info is ‘0.’ The third and fourth extra blocks ErBLK3 and ErBLK4 are unused, and corresponding flag information Flag Info is ‘1.’

The address adjustment circuit 1292 allocates main memory block addresses to the third and fourth extra blocks ErBLK3 and ErBLK4 whose flag information Flag Info is ‘1.’ More specifically, since the last main memory block address information LMB Addr Info is ‘X+4,’ a main memory block address ‘X+5’ is allocated to the third extra block ErBLK3, a main memory block address ‘X+6’ is allocated to the fourth extra block ErBLK4, and these main memory block addresses are stored in the adjustment table TT. In this case, the last main memory block address information LMB Addr Info is updated to ‘X+6.’

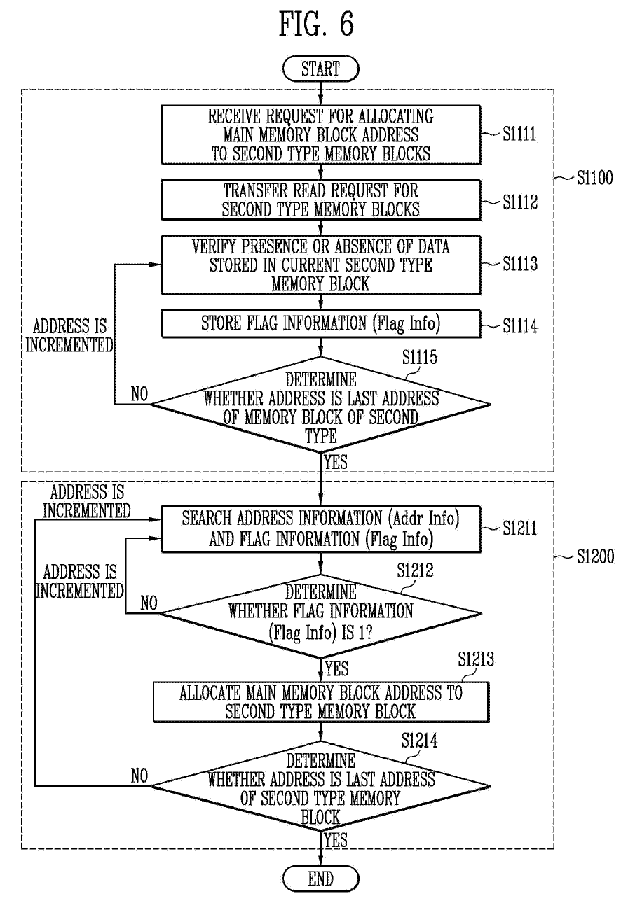

FIG. 6 illustrates an address allocation method for a second-type memory block according to an embodiment of the present disclosure.

Referring to FIG. 6, the address allocation method includes a flag setting process S1100 based on the presence or absence of data stored in the second-type memory block, and a process S1200 for allocating a main memory block address to the second-type memory block based on flag information.

In the flag setting process S1100, a request for allocating a main memory block address to a second-type memory block is received from the control logic 130 in FIG. 3 in step S1111. When the address allocation request is received, a read request for the second-type memory blocks BLK 2s is transferred to the control logic 130 in step S1112.

Upon receiving the read request, the control logic 130 controls the peripheral circuit 120 in FIG. 1 to perform a read operation for each of the second-type memory blocks BLK 2s, and data corresponding to the read operation for each of the second-type memory blocks BLK 2s is stored in the page buffer PB1 to PBn in FIG. 1.

The presence or absence of data stored in each of the second-type memory blocks BLK 2s is verified based on the data stored in the page buffer PB1 to PBn in the data verification circuit 128 in step S1113, and corresponding flag information Flag Info is stored in the address management circuit 127 in step S1114. The flag information Flag Info “1” indicates an erased state, meaning that the second-type memory block is unused, while the flag information Flag Info “0” indicates a programmed state, meaning that the second-type memory block is in use. In this case, it is determined, in step S1115, whether a second-type memory block address of a current second-type memory block under verification corresponds to the last address among the second-type memory blocks BLK 2s, based on the current address information Addr Info associated with the current second-type memory block. When the second-type memory block address of the current second-type memory block does not correspond to the last address, a current second-type memory block address under verification is incremented. After that, the presence of data stored in a second-type memory block corresponding to the incremented second-type memory block address is verified in step S1113, and step S1114 of storing corresponding flag information is performed. Steps S1113 and S1114 are repeatedly performed until the current second-type memory block address corresponds to the last address.

When the flag setting process S1100 is completed, the main memory block address allocation process S1200 starts.

The address information Addr Info and the flag information Flag Info stored in the address management circuit 127 may be searched in step S1211. It is determined whether the searched flag information Flag Info is “1” in step S1212. If the searched flag information Flag Info is “1,” a main memory block address is allocated to the corresponding second-type memory block having the flag information “1” in step S1213. More specifically, based on the last main memory block address information LMB Address Info, a main memory block address obtained by adding ‘1’ to the last allocated main memory block address is allocated to the corresponding second-type memory block, and the last main memory block address information LMB Address Info is updated in step S1213. On the other hand, if the searched flag information Flag Info is not “1,” the second-type memory block address corresponding the searched flag information Flag Info is incremented and the process returns to S1211.

After allocating the main memory block address to the corresponding second-type memory block in step S1213, it is determined, in step S1214, whether the second-type memory address of the corresponding second-type memory block with the flag information “1” corresponds to the last address of the second-type memory blocks BLK 2s using the address information Addr Info. If it is determined in step S1214 that the second-type memory address corresponds to the last address, the main memory block address allocation process S1200 is terminated. On the other hand, if it is determined in step S1214 that the second-type memory address does not correspond to the last address, the second-type memory block address is incremented and the process returns to step 1211, such that the main memory block address allocation process S1200 is repeated.

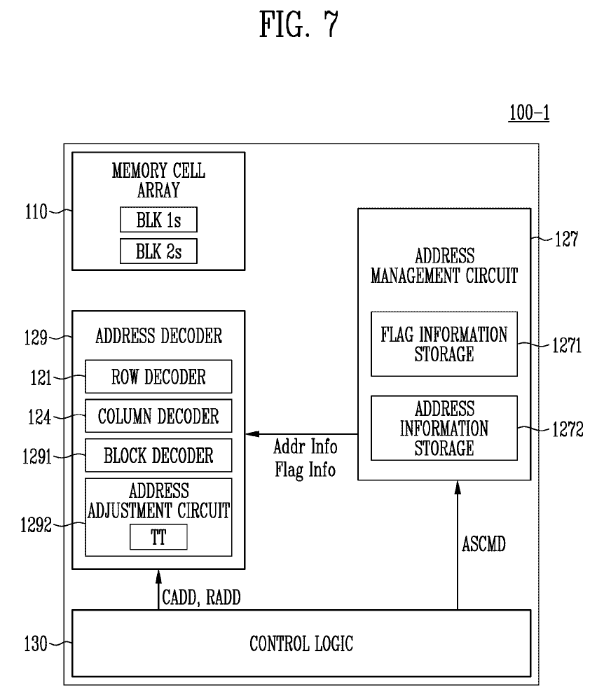

FIG. 7 illustrates a memory device 100-1 according to another embodiment of the present disclosure.

The description of the memory device 100-1 in FIG. 7 overlaps with the description of the memory device 100 in FIG. 3, so the overlapping descriptions are omitted, and only the differences will be described.

Referring to FIGS. 3 and 7, the memory device 100 shown in FIG. 3 performs a read operation on the second-type memory blocks BLK 2s and determines whether each of the second-type memory blocks BLK 2s is in an erased state or in a non-erased or stored state. Based on the determination result, the flag information Flag Info is set.

In contrast, the memory device 100-1 shown in FIG. 7 includes flag information Flag Info that is preset. Therefore, the memory device 100-1 shown in FIG. 7 neither performs a read operation on the second-type memory blocks BLK 2s nor includes the data verification circuit 128 in FIG. 3 which verifies read data.

The address adjustment circuit 1292 allocates a first-type memory block address (or main memory block address) to an unused second-type memory block among the second-type memory blocks BLK 2s based on the last main memory block address information LMB Address Info stored therein, and the preset flag information Flag Info and corresponding address information Addr Info received from the address management circuit 127. The unused second-type memory block may be predetermined by the preset flag information.

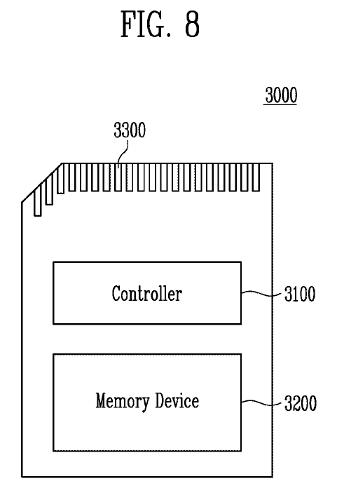

FIG. 8 illustrates a memory card system 3000 according to an embodiment of the present disclosure.

Referring to FIG. 8, the memory card system 3000 may include a controller 3100, a memory device 3200, and a connector 3300.

The controller 3100 may be coupled to the memory device 3200. The controller 3100 may access the memory device 3200. For example, the controller 3100 may control a program, read, erase, or background operation of the memory device 3200. The controller 3100 may provide an interface between the memory device 3200 and a host. The controller 3100 may drive firmware for controlling the memory device 3200. For example, the controller 3100 may include components, such as a Random Access Memory (RAM), a processing unit, a host interface, a memory interface, and an ECC circuit.

The controller 3100 may communicate with an external device through the connector 3300. The controller 3100 may communicate with an external device (e.g., a host) based on a specific communication protocol. For example, the controller 3100 may communicate with the external device through at least one of various communication protocols such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and non-volatile memory express (NVMe) protocols. For example, the connector 3300 may be defined by at least one of the above-described various communication protocols.

The memory device 3200 may include a plurality of memory cells and be configured in the same manner as the memory device 100 as described above with reference to FIG. 1.

The controller 3100 and the memory device 3200 may be integrated into a single semiconductor device to form a memory card. For example, the controller 3100 and the memory device 3200 may be integrated into a single semiconductor device to form a memory card, such as a personal computer memory card international association (PCMCIA) card, a compact flash (CF) card, a smart media card (SM or SMC), a memory stick, a multimedia card (MMC, RS-MMC, MMCmicro, or eMMC), an SD card (SD, miniSD, microSD, or SDHC), a universal flash storage (UFS), and the like.

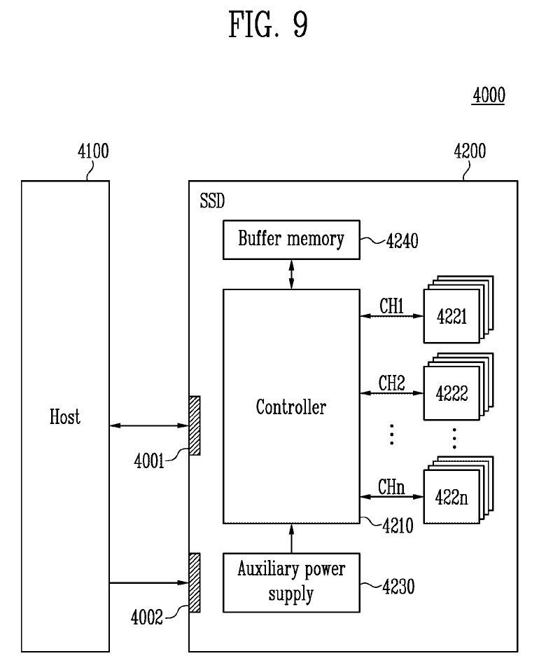

FIG. 9 illustrates a solid state drive (SSD) system 4000 according to an embodiment of the present disclosure.

Referring to FIG. 9, the SSD system 4000 may include a host 4100 and an SSD 4200. The SSD 4200 may exchange signals with the host 4100 through a signal connector 4001 and may receive power PWR through a power connector 4002. The SSD 4200 may include a controller 4210, a plurality of memory devices 4221 to 422n, an auxiliary power supply 4230, and a buffer memory 4240.

The controller 4210 may control the plurality of memory devices 4221 to 422n in response to signals received from the host 4100. In an embodiment, the signals may be based on the interfaces of the host 4100 and the SSD 4200. For example, the signals may be defined by at least one of various interfaces such as universal serial bus (USB), multimedia card (MMC), embedded MMC (eMMC), peripheral component interconnection (PCI), PCI-express (PCI-E), advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and non-volatile memory express (NVMe) interfaces.

The plurality of memory devices 4221 to 422n may include a plurality of memory cells configured to store data. Each of the plurality of memory devices 4221 to 422n may be configured in the same manner as the memory device 100 as shown in FIG. 1.

The auxiliary power supply 4230 may be coupled to the host 4100 through the power connector 4002. The auxiliary power supply 4230 may be supplied and charged with the power from the host 4100. The auxiliary power supply 4230 may supply the power of the SSD 4200 when the power is not smoothly supplied from the host 4100. For example, the auxiliary power supply 4230 may be positioned inside or outside the SSD 4200. For example, the auxiliary power supply 4230 may be arranged in a main board and supply auxiliary power to the SSD 4200.

The buffer memory 4240 may serve as a buffer memory of the SSD 4200. For example, the buffer memory 4240 may temporarily store data received from the host 4100 or data received from the plurality of memory devices 4221 to 422n, or may temporarily store metadata (e.g., mapping tables) of the memory devices 4221 to 422n. The buffer memory 4240 may include volatile memories such as DRAM, SDRAM, DDR SDRAM, and LPDDR SDRAM, or non-volatile memories such as FRAM, ReRAM, STT-MRAM, and PRAM.

This technology increases user data storage capacity of a memory device by allocating a main block address to an unused memory block among special-purpose memory blocks.

While the exemplary embodiments of the present disclosure have been disclosed for illustrative purposes, those skilled in the art will appreciate which various modifications, additions and substitutions are possible. Thus, it is intended which the present invention cover all such modifications provided they come within the scope of the appended claims and their equivalents.

What is claimed is:

1. A memory device comprising:
a memory cell array including first-type memory blocks, to which main memory block addresses are allocated and in which user data is stored, and second-type memory blocks in which no user data is stored;
an address management circuit configured to request a read operation for the second-type memory blocks and to set flag information indicating a usage status of each of the second-type memory blocks based on data read from each of the second-type memory blocks; and
an address adjustment circuit configured to selectively allocate, based on the flag information for each of the second-type memory blocks, a main memory block address to the second-type memory blocks.

2. The memory device of claim 1, further comprising a data verification circuit configured to output a flag value based on the data read from each of the second-type memory blocks,
wherein the address management circuit sets a final flag value among flag values related to each of the second-type memory blocks from the data verification circuit as the flag information.

3. The memory device of claim 1, wherein the address management circuit comprises a flag information storage configured to store the flag information for each of the second-type memory blocks and an address information storage configured to store address information of the second-type memory blocks corresponding to the flag information, and
wherein the address management circuit provides the flag information and the address information to the address adjustment circuit.

4. The memory device of claim 1, wherein the address adjustment circuit selectively allocates a main memory block address to each of the second-type memory blocks based on the flag information, corresponding address information, and last main memory block address information,
wherein the last main memory block address information includes information on a last main memory block address most recently allocated to a memory block for storing user data.

5. The memory device of claim 4, wherein the address adjustment circuit allocates a next main memory block address following the last main memory block address to a second-type memory block with flag information indicating an erased state among the second-type memory blocks.

6. The memory device of claim 1, wherein the address adjustment circuit comprises an adjustment table configured to store, for each unused second-type memory block, a second-type memory block address of the unused second-type memory block as a first mapping memory block address and a main memory block address mapped to the first mapping memory block address as a second mapping memory block address.

7. The memory device of claim 6, wherein the address adjustment circuit provides an address decoder with the second mapping memory block address instead of the first mapping memory block address when a received memory block address for accessing a memory block corresponds to the first mapping memory block address stored in the adjustment table.

8. The memory device of claim 1, further comprising:
a peripheral circuit configured to perform a read operation on the second-type memory blocks; and
control logic configured to control the peripheral circuit,
wherein the address management circuit receives an address allocation command for the second-type memory blocks from the control logic, and transfers a read start command for the second-type memory blocks to the control logic in response to the address allocation command.

9. A method of operating a memory device, the method comprising:
transferring a read request to second-type memory blocks among first-type memory blocks, to which main memory block addresses are allocated and in which user data is stored, and the second-type memory blocks in which no user data is stored;
setting flag information indicating a usage status of each of the second-type memory blocks based on data read from each of the second-type memory blocks; and
selectively allocating a main memory block address to each of the second-type memory blocks based on the flag information.

10. The method of claim 9, further comprising outputting a flag value based on read data,
wherein the setting of the flag information comprises setting a final flag value among flag values associated with each of the second-type memory blocks as the flag information.

11. The method of claim 9, wherein the setting of the flag information comprises storing the flag information and address information of the second-type memory blocks corresponding to the flag information.

12. The method of claim 9, wherein the allocating of the main memory block address comprises selectively allocating a main memory block address to each of the second-type memory blocks based on the flag information, address information corresponding to the flag information, and last main memory block address information,
wherein the last main memory block address information includes information on a last main memory block address most recently allocated to a memory block for storing user data.

13. The method of claim 12, wherein the main memory block address allocated corresponds to a next main memory block address following the last main memory block address.

14. The method of claim 9, wherein, when an adjustment table stores, for each unused second-type memory block, a second-type memory block address of the unused second-type memory block as a first mapping memory block address and a main memory block address mapped to the first mapping memory block address as a second mapping memory block address,
the method further comprises providing the second mapping memory block address corresponding to the first mapping memory block address to an address decoder when a received memory block address for accessing a memory block corresponds to the first mapping memory block address stored in the adjustment table.

15. The method of claim 9, wherein the transferring of the read request is performed when an address allocation command for the second-type memory blocks is received.

16. A memory device, comprising:
a memory cell array including first-type memory blocks, to which main memory block addresses are allocated and in which user data is stored, and second-type memory blocks in which no user data is stored;
an address management circuit configured to store preset flag information indicating a usage status of each of the second-type memory blocks; and
an address adjustment circuit configured to selectively allocate a main memory block address to each of the second-type memory blocks based on the preset flag information.

17. The memory device of claim 16, wherein the address adjustment circuit selectively allocates the main memory block address to each of the second-type memory blocks based on the preset flag information, address information of the second-type memory blocks corresponding to the preset flag information, and last main memory block address information, wherein the last main memory block address information includes information on a last main memory block address most recently allocated to a memory block for storing user data.

18. The memory device of claim 17, wherein the address adjustment circuit allocates a next main memory block address following the last main memory block address to a second-type memory block with flag information indicating an erased state among the second-type memory blocks.

19. The memory device of claim 16, wherein the address adjustment circuit comprises an adjustment table configured to store, for each unused second-type memory block, a second-type memory block address of the unused second-type memory block as a first mapping memory block address and a main memory block address mapped to the first mapping memory block address as a second mapping memory block address.

20. The memory device of claim 19, wherein the address adjustment circuit provides an address decoder with the second mapping memory block address instead of the first mapping memory block address when a received memory block address for accessing a memory block corresponds to the first mapping memory block address stored in the adjustment table.
